(19) United States
(12) Patent Application Publication
(10) Pub. No.: US 2015/0219549 A1
(43) Pub. Date: Aug. 6, 2015

(54) APPARATUS THAT MEASURES THE AMOUNT OF HYDROGEN PENETRATED INTO METAL

(71) Applicants: JFE STEEL CORPORATION, Tokyo (JP); TOKYO INSTITUTE OF TECHNOLOGY, Tokyo (JP)

(72) Inventors: Shinji Ootsuka, Tokyo (JP); Hiroki Nakamaru, Tokyo (JP); Sakae Fujita, Tokyo (JP); Tooru Tsuru, Tokyo (JP)

(21) Appl. No.: 14/429,880

(22) PCT Filed: Oct. 3, 2012
(86) PCT No.: PCT/JP2012/076256

§ 371 Date: Mar. 20, 2015

(51) Int. Cl. G01N 17/02; G01N 27/30

(52) U.S. Cl. CPC G01N 17/02; G01N 27/304

(57) ABSTRACT

A measuring apparatus is capable of measuring an amount of hydrogen penetrated into a metal. In the apparatus, a specimen formed of a metallic material has one surface exposed to a corrosive environment to serve as a penetration surface of hydrogen generated by a corrosion reaction while having the other surface as a hydrogen detection surface. On the hydrogen detection surface side, an electrochemical cell constituted of a plurality of cells is disposed. At least one of the plurality of cells is configured as a base cell to compensate for a residual current so that anodic currents detected in other cells than the base cell are compensated for based on the residual current detected in the base cell, and an amount of hydrogen penetrating from a corrosive surface side is calculated based on the compensated currents.

### TECHNICAL FIELD

This disclosure relates to an apparatus that measures the amount of hydrogen penetrated into metal, which is capable of accurately measuring the amount of hydrogen penetrating into metal due to the corrosion of the metal.

### BACKGROUND

In recent years, in view of preventing global warming, there are demands to improve energy efficiency by reducing the weight of moving bodies such as automobiles, marine vessels, and train cars. In automobiles, in particular, improvement in fuel efficiency of gasoline is required. In this regard, materials are also required to be reduced in weight and, in particular, high-strengthened steel sheets are in greater use as steel materials to ensure equal safety even when the sheet thickness is reduced.

However, it is known that a steel material increased in strength becomes more susceptible to a “delayed fracture” phenomenon. The “delayed fracture” is significantly caused along with the increase in strength of the steel material, and becomes particularly noticeable in high-strength steel having a tensile strength of equal to or larger than 1,180 MPa (“Matsuyama Shinsaku: Delayed Fracture, THE NIKKAN KOGYO SHIMBUN, LTD., Tokyo (1989)”). “Delayed fracture” is a phenomenon that generates sudden brittle fractures in a high strength steel sheet under static load (load stress equal to or smaller than the tensile strength) applied for a certain period of time without exhibiting hardly any plastic deformation in appearance. The delayed fracture herein particularly refers to hydrogen embrittlement induced by hydrogen penetrating into the steel material.

Hydrogen penetrating into a steel material is considered to be part of hydrogen generated along with corrosion of the steel sheet. With this in view, there have been proposed various methods of evaluating the delayed fracture focusing on hydrogen penetrating into the steel material.

For example, JP 2005-69815 A proposes an evaluation method of delayed fracture characteristics of a steel material by adding diffusible hydrogen to the steel material through cathodic charge to measure the limit amount of diffusible hydrogen in which the steel material is galvanized to prevent hydrogen from being discharged from the steel material during measurement of the limit amount of diffusible hydrogen.

However, the technology disclosed in JP 2005-69815 A employs an accelerated test which causes hydrogen to be forced to penetrate into the steel through cathodic charge and, therefore, only capable of determining the order of superiority in terms of susceptibility to delayed fracture depending on the type of the sample material under conditions different from those of an actual use environment. Accordingly, there cannot be obtained information to determine whether or not an amount of hydrogen that penetrates due to corrosion under an actual use environment causes delayed fracture.

Further, in recent years, various studies have been reported on the hydrogen penetration. For example, “Takai et al.: Summary of Corrosion Engineering Symposium, Vol. 170, pp. 47-54 (2010)” reports on the behavior of hydrogen penetration evaluated with the use of ammonium thiocyanate. “Takai et al.: Summary of Corrosion Engineering Symposium, Vol. 170, pp. 47-54 (2010)” compares hydrogen penetration observed by using ammonium thiocyanate with hydrogen penetration caused by cathodic charge.

However, the amount of hydrogen penetration obtained by the evaluation method with the use of ammonium thiocyanate as disclosed in “Takai et al.: Summary of Corrosion Engineering Symposium, Vol. 170, pp. 47-54 (2010)” cannot be considered to be equal to the amount caused by surface corrosion and, thus, it cannot be measured how the behavior of hydrogen penetration is influenced by, for example, zinc coating or the like which is used for the purpose of anti-rust in the field of automobiles in recent years.

Further, “Ohmura et al.: TETSU TO HAGANE—JOURNAL OF THE IRON AND STEEL INSTITUTE OF JAPAN, Vol. 91, No. 5, p. 42 (2005)” reports on high-strength bolts which were left air-exposed and subjected to corrosion for a certain period of time were collected and hydrogen concentrations occluded in the bolts were measured. “Ohmura et al.: TETSU TO HAGANE—JOURNAL OF THE IRON AND STEEL INSTITUTE OF JAPAN, Vol. 91, No. 5, p. 42 (2005)” also reports on the results of investigating the behavior of hydrogen penetration caused by corrosion resulting from air exposure. The investigation employed an electrochemical hydrogen permeation method in which test equipment to expose one surface of a steel sheet to the external environment was used to detect the changes in anodic current value from the other surface side of the steel sheet, based on which the behavior of hydrogen penetration was investigated.

However, the data obtained by the air-exposure test disclosed in “Ohmura et al.: TETSU TO HAGANE—JOURNAL OF THE IRON AND STEEL INSTITUTE OF JAPAN, Vol. 91, No. 5, p. 42 (2005)” is merely the test results all obtained under environmental factors associated with a specific geographical environment, and no consideration is given to continuously observing corrosion to be caused under various environments changing along with movement of the moving body.

Further, in the hydrogen permeation test on a steel sheet that has been air-exposed by using test equipment to expose one surface of the steel sheet to the external environment, no consideration is given to changes in residual electric current on the anode side that accompany changes in environmental temperature and, thus, the quantitativity of the measured values has also been under question.

As noted above, a steel material which is widely used as an actual material concerns the problem of delay fracture. However, it is pointed out the possibility that the problem of delay fracture similarly arises in other metallic materials in the future (see, for example, “Takatori et al.: TETSU TO HAGANE—JOURNAL OF THE IRON AND STEEL INSTITUTE OF JAPAN, Vol. 78, No. 5, p. 149 (1992)”).

As described above, in a moving body such as an automobile, its geographical environment changes along with the movement thereof and, further, it may suffer a significant change of corrosive environment in accordance with physical factors (such as vibration, accumulation and falling of dust, splashes and drying of water and mud) applied thereto.

However, there has been found no example in which the amount of hydrogen penetrated due to corrosion is measured continuously and quantitatively in a moving body which is inevitably influenced by the aforementioned physical factors such as vibration and geographical change in environment.

In view of the aforementioned circumstances, we first developed the following method, which is disclosed in Japanese Patent Application No: 2010-42800 as “the method for measuring the amount of hydrogen penetrated into a metal accompanied by corrosion through electrochemical hydrogen permeation method, in which one side of a specimen is exposed to corrosive environment to be set to the penetration surface of hydrogen produced by corrosive reaction while the other side of the specimen is set to a hydrogen detection surface and, when the flux of hydrogen diffused to the hydrogen detection surface is measured as an anodic current in a state that the potential on the side of the hydrogen detection surface is held to −0.1 to +0.3V vs SCE, an electrochemical cell constituted of a group of a plurality of cells obtained by dividing the electrochemical cell at least in to two is arranged on the side of the hydrogen detection surface of the specimen, the cells in the cell group each being filled with an electrolyte aqueous solution having a pH of 9 to 13 and at least one of the cells serving as a base cell for compensating the residual electric current, a protective film for cutting off the contact with the corrosive environment is provided to a portion serving as the hydrogen penetration surface side in the base cell and the anodic current value detected in the cell other than the base cell is compensated by the residual electric current value detected in the base cell, to thereby calculate the amount of hydrogen penetrating from a corrosive surface on the basis of the compensated anodic current value”.

The disclosure in Japanese Patent Application No: 2010-42800 allows accurate measurement of the amount of hydrogen penetrated into a metal due to corrosion, in consideration of changes in the residual electric current on the anode side resulting from temperature changes in the environment.

It could therefore be helpful to provide an apparatus to measure the amount of hydrogen penetrated into metal, which can be preferably applied to the “method of measuring the amount of hydrogen penetrated into metal” disclosed in Japanese Patent Application No: 2010-42800.

### SUMMARY

We thus provide:

1. An apparatus that measures the amount of hydrogen generated due to corrosion of a specimen formed of a metallic material and penetrated into the metallic material by using an electrochemical hydrogen permeation method, the specimen having one surface exposed to a corrosive environment to serve as a penetration surface of hydrogen generated by a corrosion reaction while having the other surface as a hydrogen detection surface, the apparatus comprising:

an electrochemical cell constituted of a group of a plurality of cells disposed on the hydrogen detection surface side, the cells in the cell group each being filled with an electrolyte aqueous solution having a pH of 9 to 13 and having a reference electrode and a counter electrode independently disposed therein,

wherein at least one of the plurality of cells in the cell group is configured as a base cell for compensating a residual electric current, the base cell having a protective film formed on a region on the hydrogen penetration surface side corresponding to a hydrogen detection region thereof for the purpose of cutting off a contact with a corrosive environment, and

wherein anodic current values detected in other cells than the base cell are compensated based on the residual electric current value detected in the base cell, and an amount of hydrogen penetrating from a corrosive surface side is calculated based on the compensated anodic current values.

2. The apparatus that measures the amount of hydrogen penetrated into a metal according to the aforementioned reference 1, in which the reference electrode employs an Ir/Ir oxide electrode.
3. The apparatus that measures the amount of hydrogen penetrated into a metal according to the aforementioned reference 1 or 2, in which the electrolyte aqueous solution contains an organic compound added thereto for the purpose of antifreezing.
4. The apparatus that measures the amount of hydrogen penetrated into a metal, according to any one of the aforementioned references 1 to 3, in which the organic compound added to the electrolyte aqueous solution comprises isopropyl alcohol, glycerin, ethylene glycol, dimethylsulfoxide or dimethylformamide.
5. The apparatus that measures the amount of hydrogen penetrated into a metal, according to any one of the aforementioned references 1 to 4, in which the electrochemical cell filled with the electrolyte aqueous solution have a gas body disposed therein, the gas body being arranged without coming into contact with the hydrogen detection surface.

The apparatus is capable of accurately detecting the amount of hydrogen penetrated into metal due to corrosion.

Further, the use of the apparatus allows continuous monitoring of the amount of hydrogen penetrating into a metallic material, the hydrogen being generated due to corrosion occurring at each part of the metallic material constituting a moving body such as automobiles, marine vessels, and rail cars under corrosive environment to which the moving body is exposed during use thereof, to thereby provide information needed to determine whether or not the delayed fracture is to be caused by the amount of hydrogen to penetrate due to corrosion that is to occur under the actual use environment.

### BRIEF DESCRIPTION OF THE DRAWINGS

Our apparatus will be further described below with reference to the accompanying drawings.

FIG. 1 is an explanatory view illustrating an electrochemical hydrogen permeation method.

FIG. 2 is a view schematically illustrating an example of a measuring apparatus.

FIG. 3 is a view schematically illustrating reactions in a cell on a corrosive surface (hydrogen penetration surface) side with no protective film formed thereon and on a hydrogen detection surface side.

FIG. 4 is a view illustrating an example where a gas body is disposed inside a cell.

FIG. 5 is a view illustrating another example where a gas body is disposed inside a cell.

FIG. 6 is a graph showing changes in temperature and humidity in Example.

FIG. 7 is a graph showing temporal change of an anodic current detected in each channel.

FIG. 8 is a picture showing external appearances of experimented samples on the corrosive surface side.

FIG. 9 is a view schematically illustrating a measurement system in which the measuring apparatus mounted on an automobile to measure an anodic current.

FIG. 10 is a graph showing differences in anodic current density detected at different positions of the automobile, in comparison between when compensation of the residual electric current was performed based on our reference electrode (Inventive Example) and when such compensation was not performed (Comparative Example).

FIG. 11 is a view schematically illustrating another example of the measuring apparatus.

FIG. 12 is a graph showing the change in minimum temperature during the measurement period.

### REFERENCE SIGNS LIST

1 electrolysis cell
2 sample
3 reference electrode
4 electrode
4b counter electrode
5 glass frit
6 specimen (steel sheet)
7 cell
7a base cell
8 counter electrode
9 reference electrode
10 protective film
11 gas body
12 electrolyte
13 O-ring

### DETAILED DESCRIPTION

Although our apparatus is applicable to any self-movable moving body, including: various vehicles such as automobiles, autobicycles, and rail cars; marine vessels; and aircraft, a representative example is hereinafter described in detail by reference to an automobile. Further, a steel sheet is described herein as a representative example, although a metallic material to be evaluated is not necessarily limited thereto.

An amount of hydrogen generated due to corrosion of a metallic material and penetrated into a metallic material is measured based on the measurement principle of electrochemical hydrogen permeation in which a steel sheet surface on the hydrogen penetration surface side is exposed to a corrosion environment so that hydrogen generated due to corrosion penetrates into the steel, and the hydrogen thus penetrated is taken out from the other side, to thereby measure the amount of hydrogen penetrated.

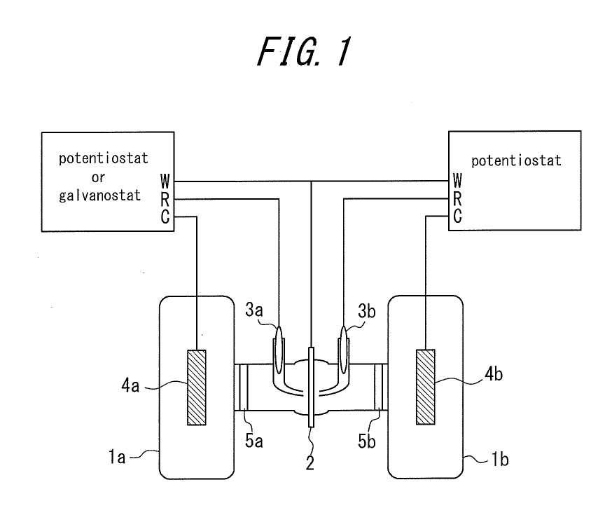

The electrochemical hydrogen permeation was developed by Devanathan and Stachurski in 1962 (“M. A. V. Devanathan, Z. Stachurski: Proc. Roy. Soc. London, Ser. A, 270, 90 (1962)”), which uses two electrolysis cells 1a, 1b arranged opposite to each other across a sample 2, as schematically illustrated in FIG. 1. In FIG. 1, the sample surface on the electrolysis cell 1a side on the left is cathode-polarized at a constant potential or at a constant current to generate and charge hydrogen. The sample 2 is anode-polarized by the electrolysis cell 1b on the right at a constant potential to oxidize hydrogen permeated through the sample 2 into hydrogen ions to thereby obtain the amount of hydrogen thus permeated based on the current value thereof.

FIG. 1 also illustrates reference electrodes 3a, 3b, and electrodes 4a, 4b. In particular, the electrode 4b is specifically referred to as counter electrode or coefficient electrode. The electrode 4a connects to a potentiostat to apply a constant potential or a galvanostat to apply a constant current, while the electrode 4b connects to a potentiostat to apply a constant potential. Glass fits 5a, 5b are also provided to remove influence of gas and the like generated by the counter electrodes 4a, 4b.

The aforementioned electrochemical hydrogen permeation itself has conventionally been well-known as “a method of measuring a hydrogen diffusion coefficient in a steel sheet”.

The electrochemical hydrogen permeation is originally adapted to cathodize one side of a sample to electrolytically charge hydrogen while anodizing the other side of the sample to take out the hydrogen therefrom as illustrated in FIG. 1. A study on one of the applications of this technique has been reported in which a surface corresponding to the hydrogen-charging surface is exposed to a corrosive environment (“Ohmura et al.: TETSU TO HAGANE—JOURNAL OF THE IRON AND STEEL INSTITUTE OF JAPAN, Vol. 91, No. 5, p. 42 (2005)”).

However, as described above, the measuring method disclosed in “Ohmura et al.: TETSU TO HAGANE—JOURNAL OF THE IRON AND STEEL INSTITUTE OF JAPAN, Vol. 91, No. 5, p. 42 (2005)” involves a problem in that no consideration is given to the change in measured current value resulting from temperature changes. Further, the anodic current to be measured on the hydrogen detection surface side in the electrochemical hydrogen permeation is superposed with a passive current of the sample material as well as the oxidation current of hydrogen. This passive current accounts for the most part of the residual electric current, and is influenced by various factors. In particular, the passive current greatly varies depending on the temperature.

The anodic current to be measured on the hydrogen detection surface side by the electrochemical hydrogen permeation method is weak and, thus, an accurate anodic current value cannot be obtained unless the temperature dependency of the residual electric current is compensated.

We found that the electrochemical cell to be provided on the hydrogen detecting surface side is formed of a group of a plurality of cells obtained by dividing the cell on the same specimen into at least two, at least one of the cells serving as a base cell for compensating to compensate for the residual electric current, and a protective film to cut off contact with a corrosion environment is provided on a region on the hydrogen penetration surface side corresponding to the hydrogen detection region of the base cell, to thereby compensate for the temperature dependency of the residual electric current.

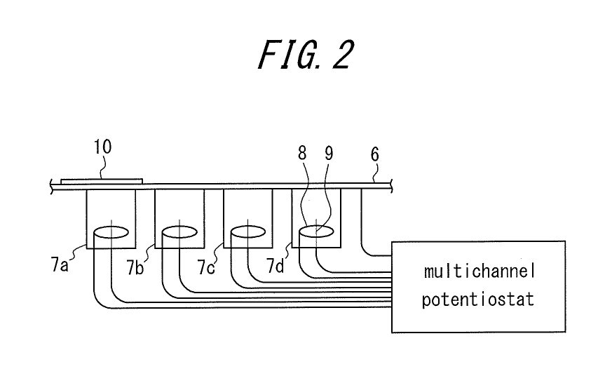

FIG. 2 schematically illustrates an example of a measuring apparatus. The example of FIG. 2 includes four cells 7a, 7b, 7c, and 7d on the hydrogen detection side of a steel sheet 6 as a specimen, in which the leftmost cell 7a is configured as the base cell to compensate for the residual electric current. FIG. 2 also illustrates a counter electrode (Pt wire) 8, and a reference electrode (Ir wire) 9. At least two cells are required, preferably without exceeding a maximum of four because too many cells make the handling thereof complicated.

In FIG. 2, the surface temperature of the steel sheet in each cell and the temperature of the electrolyte solution in each cell are set to the same temperatures. Further, a protective film 10 is provided on the hydrogen penetration surface side of the base cell 7a. The portion thus covered by the protective film 10 is exempted from corrosion and, thus, no hydrogen penetrates thereinto. Therefore, the current to be measured on the hydrogen detection surface side of the base cell can be considered as the residual electric current itself.

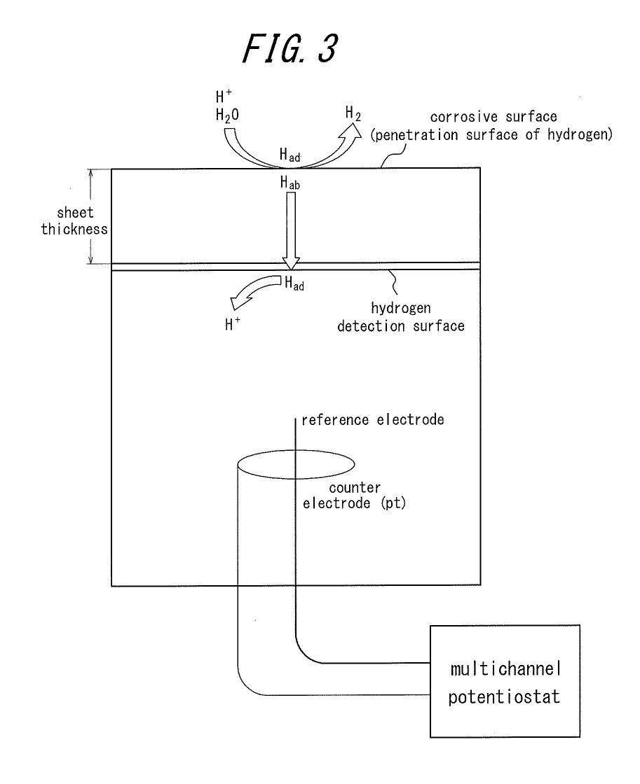

FIG. 3 schematically illustrates reactions to occur on the corrosive surface (hydrogen penetration surface) side, and on the hydrogen detection surface side in a cell with no protective film (also referred to as channel).

The surface potential on the hydrogen detection surface side is retained at a potential sufficient enough to cause ionization reaction of hydrogen to take out all the hydrogen reached to the detection surface side through diffusion, as hydrogen ions. The steel sheet surface on the hydrogen detection surface side is passivated and, therefore, the anodic current detected on the hydrogen detection side can be considered to substantially correspond to the hydrogen permeation current.

Therefore, the current value thus obtained is compensated for based on the residual electric current value obtained in the base cell, to thereby obtain an accurate anodic current value irrespective of the changes in residual electric current resulting from temperature changes, with the result that the amount of permeated hydrogen can be accurately calculated based on the anodic current value.

To retain the steel sheet on the hydrogen detection surface side in a passive state, the solution in the anode electrode chamber needs to be an electrolyte solution having a pH of 9 to 13. The reason is as follows. With pH less than 9, the passive state of the steel surface is difficult to maintain at a predetermined potential, whereas with pH exceeding 13, there may be caused great damage to the environment in the case of accidental leakage. NaOH solution of 0.1 to 0.2 M (mole/liter) is suitably employed as the electrolyte solution with proper pH. However, the electrolyte solution is not necessarily limited to NaOH solution of 0.1 to 0.2 M, and may be any electrolyte solution as long as it is capable of ensuring the passive state of the steel sheet surface when retaining the steel sheet surface on the hydrogen detection surface side at a potential sufficient enough to cause ionization reaction of hydrogen. Further, it is advantageous to use a gelled electrolyte in place of an electrolyte solution in terms of preventing leakage as well as ease in handling.

Further, the hydrogen detection surface needs to be constantly retained at a potential ranged from −0.1 to +0.3V vs SCE. The reason is that the potential of the hydrogen detection surface falling out of the range fails to obtain a stable hydrogen ionization current.

SCE refers to a saturated calomel electrode, and the potential of SCE with respect to the standard hydrogen electrode (SHE) is obtained as +0.244V (vs SHE, 25° C.).

As the reference electrode to control the potential, various electrodes currently available for practical use can be employed.

However, in using an electrode containing a chloride such as Ag/AgCl electrode, the solution in the anode electrode chamber may be contaminated by chloride ions which may destroy the passive state on the sample surface to increase the residual electric current, possibly leading to inaccuracy in measured value.

We found that Ir wire immersed in the solution in the anode electrode chamber makes the reference electrode as Ir/Ir oxide electrode, which allows a stable current to be obtained over a long period. That is, the Ir/Ir oxide electrode is most preferred as the reference electrode, which can stably provide a potential of about −0.04V vs SSE.

SSE refers to a silver-silver chloride electrode, and the potential of SSE with respect to the standard hydrogen electrode (SHE) is obtained as +0.199V (vs SHE, 25° C.).

Further, the surface of the hydrogen detection surface may preferably be covered with a metal that is high in hydrogen diffusion constant and capable of accelerating the oxidation reaction of hydrogen. Examples of such a metal may include palladium (Pd), a palladium (Pd) alloy, and nickel (Ni). The hydrogen detection surface thus covered with such a metal or an alloy is capable of maintaining the residual electric current thereon at a low value, and also capable of accelerating the oxidation reaction of penetrating hydrogen on the hydrogen detection surface, to thereby increase sensitivity to the anodic current obtained as a result of the ionization of hydrogen. Pd is larger in hydrogen diffusion constant than Ni, and also has the advantage of reducing the residual electric current.

In coating the surface with Pd or a Pd alloy, the surface may be subjected to cathode electrolysis in an aqueous solution containing palladium ions such as [Pd(NH₃)₄]Cl₂.H₂O, to thereby form a plating on the surface. Pd—Ni alloy and Pd—Co alloy may be used as the Pd alloy. The Pd plating or the Pd alloy plating may preferably be 10 to 100 nm in film thickness.

In covering the surface with Ni, the surface may be subjected to cathode electrolysis in a known plating bath such as a Watts bath, to thereby form a Ni plating on the surface. The Ni plating may also preferably be 10 to 100 nm in film thickness.

Further, a Pd or Pd-alloy plating may be formed on the Ni plating.

The protective film to be provided on the hydrogen penetration surface is not particularly limited as long as it is capable of cutting off a corrosive environment. A specific example thereof may include a stainless foil attached to be pasted via an organic adhesive or the like.

As described above, the amount of hydrogen penetrating into a metal due to corrosion can be accurately detected, irrespective of the changes in environment such as temperature changes.

Therefore, the measuring apparatus can be attached to a moving body such as an automobile, a marine vessel, and a rail car so that the amount of hydrogen penetrating into the metallic material constituting the moving body can be continuously accurately monitored, irrespective of the change in environment to which each part of the metallic material is exposed during use.

As a result, a precise judgment can be made for each moving body as to whether or not the delayed fracture is to be caused by the amount of hydrogen to penetrate due to corrosion that is to occur under an actual use environment of the moving body.

In the meantime, we also found that the solution may leak out from within the cell under conditions simulating a winter corrosive environment. Our investigation of the cause of the solution leakage revealed that the solution inside the cell freezes and swells at low temperature, causing damage to the cell.

For the accurate monitoring of the hydrogen penetrating into the metallic site of a moving body, the amount of penetrating hydrogen needs to be stably measured even in winter driving.

In view of the above, we conducted further studies on an apparatus capable of stably measuring the amount of hydrogen penetrating into a metal due to corrosion, without having any damage caused to the cell which is ascribable to the frozen solution within the cell even in winter.

Under a driving environment in urban areas in general, the electrolyte solution is considered to be seldom cooled to −5° C. or lower. Thus, it can be deemed sufficient to have the freezing temperature of the electrolyte solution equal to or lower than −5° C.

The result of our studies made on a method of lowering the freezing temperature of the electrolyte solution to −5° C. or lower has identified that an organic compound effective in reducing the freezing temperature needs to be added to the electrolyte aqueous solution.

The organic compound added is not particularly limited and isopropyl alcohol, glycerin, and ethylene glycol have proved particularly suitable for use. In addition, dimethylsulfoxide (DMSO) and dimethylformamide (DMFA), which are polar solvents with low electrochemical activities, have also proved advantageously applicable.

A suitable content of the aforementioned organic compound is about 5 to 30 vol %. The freezing temperature further decreases along with the increase in added amount of the organic compound.

These are the organic compounds that are already in use as a window washer fluid to be filled and, thus, produce hardly any harmful effects in the event of leakage.

Further, we found it effective to provide a gas body inside the cell to alleviate damage to the cell main body even when the cell is exposed to an unanticipated low-temperature environment and has the electrolyte frozen, resulting in volume expansion of the electrolyte, because the gas body can contract to compensate for the volume expansion. However, even in this case, it is essential to dispose the gas body at a position without contacting the hydrogen detection surface because, otherwise, the hydrogen detection surface deteriorates in sensitivity to hydrogen penetrating therethrough, which impairs the essential significance of the apparatus.

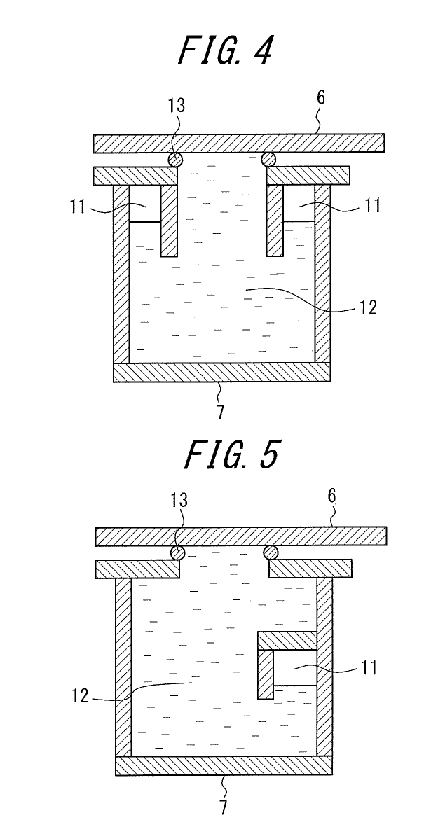

It is not specifically limited how to arrange the gas body without contacting the hydrogen detection surface, and a sac or pouch filled with air may be disposed inside the cell, or the cell may be configured to have an internal structure as illustrated in FIGS. 4 and 5. Illustrated in FIGS. 4 and 5 are a gas body 11, an electrolyte 12, and an O-ring 13.

Although the amount of the gas body is not particularly specified, it is preferred to have the gas body to 5 to 15% of the solution in volume fraction in view of the volume expansion resulting from water solidification. An inert gas may preferably used for the gas body because an oxygen-containing gas body affects the anode reaction on the hydrogen detection surface.

### EXAMPLES

### Example 1

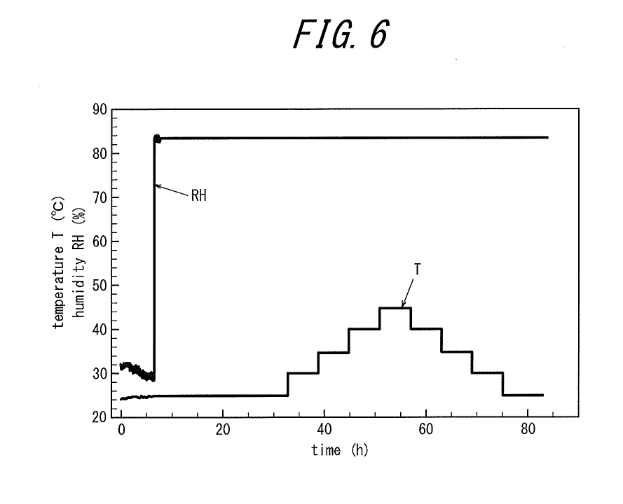

The measuring apparatus having four cells (CH1 to CH4) configured as illustrated in FIG. 2 was used to conduct an experiment. A soft steel sheet of 1.0 mm in thickness having a Pd plating formed on the hydrogen detection surface side to a thickness of 100 nm was used as a specimen. The channel 3 (CH3) served as the base cell, and a stainless foil was attached to be pasted, as the protective film, to a portion serving as the corrosive surface side of CH3. On the surface on the corrosive surface side of each cell, 300 mL of 0.5M NaCl was dropped and, subsequently, the surface was dried under conditions of 25° C. and 35% RH (relative humidity) for at least 4 hours, which was then retained at 25° C. and 85% RH (relative humidity) for at least 24 hours before increasing the temperature stepwise. The hydrogen detection surface was retained at a potential of 0V vs SCE. Changes in temperature and humidity at this time are shown in FIG. 6.

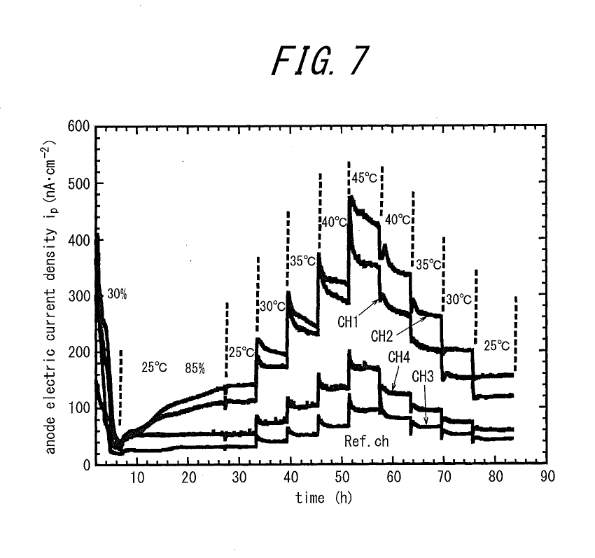

FIG. 7 shows changes in anodic current density detected in each channel corresponding to the changes in temperature shown in FIG. 6.

It can be appreciated from FIG. 7 that the anodic current density value of the reference electrode (CH3), which was supposed to have no corrosion occurring on the steel sheet surface, also increased along with the increase in temperature. The increase of the anodic current density value can be ascribed to the fact that the residual electric current resulting from the oxidation current of Pd on the hydrogen detection surface side was increased due to the increase in temperature. Thus, the temperature dependency of the residual electric current is too large to ignore.

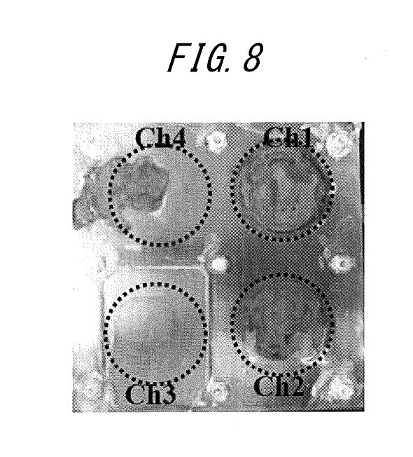

FIG. 8 is a picture showing the external appearances of the experimented samples on the corrosive surface side.

The anodic current density value of CH4 was smaller than those of the other CHs because 0.2M NaCl first dropped missed the point and, thus, the corroded area on the hydrogen penetration surface side corresponding to the detection surface was smaller.

Therefore, the anodic current density value of the reference electrode (CH3) is subtracted from each of the anodic current density values obtained by CH1 and CH2, to thereby obtain accurate current density values of permeated hydrogen in the respective cells (CH1, CH2). The current density values of permeated hydrogen thus obtained may be averaged to obtain the current density value of hydrogen permeated through the steel sheet as a specimen.

Then, based on the current density value of permeated hydrogen obtained as described above, the amount of permeated hydrogen (amount of penetrated hydrogen) is calculated by the following equations.

In this manner, the current value of permeated hydrogen and also the amount of permeated hydrogen (amount of penetrated hydrogen) can both be accurately derived.

The current density value is converted into the amount of permeated hydrogen based on the following equations.

Current density of permeated hydrogen:

i_{H}(mA/cm²=10⁻⁶ A/cm²)

Amount of permeated hydrogen per unit area:
M_{H} (mol/Sem), m_{H} (count/scm²)

M_{H}=i_{H}×1.036×10⁻¹¹ (mol/scm²),

m_{H}=i_{H}×6.24×10¹² (count/scm²)

### Example 2

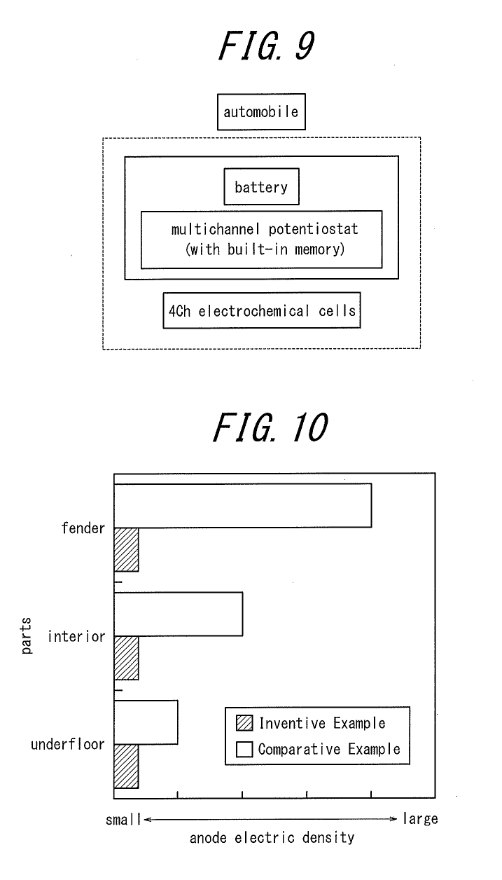

The measuring apparatus used in Example 1 was actually mounted onto an automobile to thereby construct a measurement system schematically illustrated in FIG. 9. The 4-channel cells were installed at three locations of (a) fender, (b) interior, and (c) underfloor (under surface of the floor). A multichannel potentiostat for driving by a battery was prepared and stored in a trunk together with a dedicated battery. A soft steel sheet of 1.0 mm in thickness was similarly used as the sample material as in Example 1. The automobile was driven at an average of 40 km/h inside the premise of a steelworks for 6 hours from 9:00 to 15:00 every day of 5 days from Monday to Friday. The automobile was parked in a parking lot from 15:00 to 9:00 on the following day.

FIG. 10 shows the maximum values of the anodic current density detected during the aforementioned period, in comparison between our example in which the maximum value was compensated based on the reference electrode and the comparative example in which the maximum value was not compensated.

In the initial 5 days after setting the sample piece, there could hardly be seen any corrosion in each part, and as shown in FIG. 10, no difference could be found in anodic current density of our Examples between the installation locations. In contrast, in Comparative Examples, we found differences in anodic current density between the installation locations. The differences can be considered to result from a difference in temperature between a portion (fender) which underwent temperature increase due to daytime insolation and a portion (underfloor) which hardly saw any temperature increase.

It can be appreciated from the above that accurate anodic current density values (current density values of permeated hydrogen) can be obtained without being affected by changes in temperature, by compensating the measured anodic current density values based on the reference electrode.

### Example 3

A commercially-available soft steel sheet (of 0.8 mm in thickness) was used, which was subjected to a shearing process to be sized into 40×50 mm and polished on both surfaces to #2,000. Subsequently, to remove the processing layer formed during the polishing, both surfaces were chemically polished to about 60 μm in thickness in an aqueous solution of a mixture solution of hydrofluoric acid and hydrogen peroxide solution.

### (Plating on the Hydrogen Detection Surface)

The hydrogen detection surface was Pd plated to about 100 mm in thickness, using a commercially-available K-pure palladium plating solution (manufactured by Kojima Chemicals Co., Ltd.).

### (Electrolyte Aqueous Solution in the Cells)

Sodium hydroxide aqueous solutions of 0.1 N containing dimethylsulfoxide (DMSO) at various ratios were used as the electrolyte aqueous solutions, and the freezing temperature in each case was measured.

### (Configuration of the Cell on the Detection Surface Side)

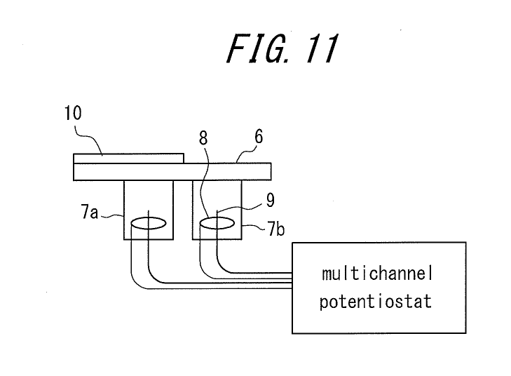

A measuring apparatus configured by including two cells illustrated in FIG. 11 was employed, in which portions corresponding to 7a and 7b were changed in configuration as follows.

### Configuration A:

The configuration of FIG. 5 was employed with no gas body provided therein, and was filled with an electrolyte solution.

### Configuration B:

The configuration of FIG. 5 was employed, in which nitrogen was filled as the gas body to the amount of 15 vol %.

As illustrated in FIG. 11, a steel sheet was installed on the cells configured as described above. An Ir/IrOₓ electrode was disposed as the reference electrode while a Pt wire was disposed as the counter electrode with the potential being set to 0V, and the cells were placed under a corrosive environment.

An epoxy resin and a stainless foil were arranged on one of the channels of the cells to have one cell exempted from corrosion to compensate changes in temperature.

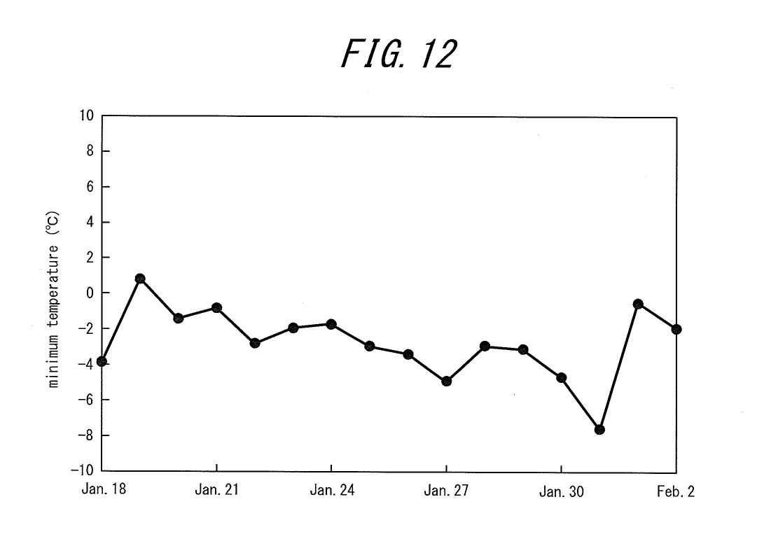

The aforementioned cells were mounted on a commercially-available automobile, which was driven inside the premise of a steelworks for 15 days from Jan. 18 to Feb. 2, 2011. FIG. 12 shows changes in daily minimum temperature in the period obtained from the website of the Japan Meteorological Agency. To prevent leakage of the content fluid resulting from freezing, driving was performed while being covered with a bag except for a steel sheet surface to be corroded.

Table 1 shows the date on which a cell fracture or leakage of the electrolyte solution was identified. Table 1 also shows maximum values of the current density obtained for each period, together with compensated maximum values of the current density obtained.

Further, after the elapse of the period, the cells of No. 2 and No. 4 were then left in a refrigeration tester of −20° C. installed in a laboratory, and checked for fractures of the cells. Table 1 also shows the results thereof.

TABLE 1

| | | | | Period I | | Period II | | Period III | | | | |
|---|---|---|---|---|---|---|---|---|---|---|---|---|
| | | | | (Jan. 18 to Jan. 22) | | (Jan. 23 to Jan. 27) | | (Jan. 28 to Feb. 2) | | | | |
| | | | | Uncom- | Compen- | Uncom- | Compen- | Uncom- | Compen- | | | |
| | | Content of | Freezing | pensated | sated | pensated | sated | pensated | sated | | | |
| | Cell | Dimethyl | Temper- | Current | Current | Current | Current | Current | Current | Comfirmed | Cell | |
| | Struc- | Sulfoxide | ature | Density | Density | Density | Density | Density | Density | Date of Cell | Fracture | |
| No. | ture | (vol %) | (° C.) | (nA/cm²) | (nA/cm²) | (nA/cm²) | (nA/cm²) | (nA/cm²) | (nA/cm²) | Fracture | at −20° C. | Remarks |
| 1 | A | 0 | −0.3 | 18 | 3 | — | — | — | — | Jan. 27 | unadmin- | Compar- |
| | | | | | | | | | | | istered | ative |
| | | | | | | | | | | | | Example |
| 2 | A | 10 | −5 | 19 | 3 | 42 | 29 | 43 | 33 | No | identi- | Inventive |
| | | | | | | | | | | fracture | fied | Example |
| 3 | A | 20 | −12 | 18 | 3 | 39 | 29 | 45 | 33 | No | unadmin- | Inventive |
| | | | | | | | | | | fracture | istered | Example |
| 4 | B | 10 | −5 | 17 | 3 | 40 | 30 | 42 | 34 | No | No | Inventive |
| | | | | | | | | | | fracture | fracture | Example |

The followings are made apparent from the results shown in Table 1.

No. 1 is a Comparative Example in which the electrolyte was formed only of a sodium hydroxide aqueous solution. Leakage of the electrolyte resulting from a fracture of the cell was identified on January 27 in Comparative Example of No. 1, whereas no fracture was identified in the cells of No. 2 to No. 4 as our Examples.

Further, we found hardly any evidence of corrosion on the steel sheet surface in Period 1, which means that there occurred no corrosion-induced hydrogen penetration into the steel sheet and thus no current value should be detected. However, we found that a relatively large current value was detected when the temperature compensation was not performed. The current value thus detected is ascribed to the residual electric current change caused by changes in temperature as described above, and it can be appreciated from Table 1 that the temperature changes can be eliminated through the temperature compensation according to our Examples.

Further, as a result of comparing No. 2 to No. 4 having dimethylsulfoxide (DMSO) added thereto with No. 1 having no DMSO added thereto, we found no difference in current value therebetween. Therefore, it can be appreciated that the measurement accuracy would not be affected by the addition of dimethylsulfoxide (DMSO).

Next, in Period 2 and Period 3, the automobile was driven on a wet road and, therefore, corrosion of the steel sheet was identified, as well as the increase in current density that has correspondingly occurred. It can be appreciated that the amount of hydrogen generated along with the corrosion and penetrated into the steel sheet was monitored.

Further, a fracture was identified in No. 2 when retained in a low-temperature environment of −20° C. On the other hand, in the cell No. 4 having a gas body disposed therein, no fracture of the cell was identified even though the electrolyte was identified as frozen. The results confirmed that a gas body disposed within the cell was capable of suppressing fracture even with respect to unanticipated changes in temperature.

### INDUSTRIAL APPLICABILITY

Our apparatus enables continuous and accurate monitoring of the amount of hydrogen generated due to corrosion of a metallic material and penetrated into the metallic material and, thus, can be suitably applied to a moving body in an ever-changing environment, where each part of the metallic material forming the moving body is exposed to a corrosive environment and corroded, and hydrogen is generated along with the corrosion and penetrates into the metallic material.

1.-5. (canceled)

6. An apparatus that measures an amount of hydrogen generated due to corrosion of a specimen formed of a metallic material and penetrated into the metallic material by using an electrochemical hydrogen permeation method, the specimen having one surface exposed to a corrosive environment to serve as a penetration surface of hydrogen generated by a corrosion reaction while having another surface as a hydrogen detection surface, the apparatus comprising:
an electrochemical cell constituted of a group of a plurality of cells disposed on a hydrogen detection surface side, the cells in the cell group each being filled with an electrolyte aqueous solution having a pH of 9 to 13 and having a reference electrode and a counter electrode independently disposed therein,
wherein at least one of the plurality of cells in the cell group is configured as a base cell to compensate for a residual electric current, the base cell having a protective film formed on a region on the hydrogen penetration surface side corresponding to a hydrogen detection region thereof to cut off contact with a corrosive environment, and
wherein anode electric current values detected in other cells than the base cell are compensated for based on the residual electric current value detected in the base cell, and an amount of hydrogen penetrating from a corrosive surface side is calculated based on the compensated anode electric current values.

7. The apparatus according to claim 6, wherein the reference electrode employs an Ir/Ir oxide electrode.

8. The apparatus according to claim 6, wherein the electrolyte aqueous solution contains an organic compound added thereto as antifreeze.

9. The apparatus according to claim 7, wherein the electrolyte aqueous solution contains an organic compound added thereto as antifreeze.

10. The apparatus according to claim 8, wherein the organic compound added to the electrolyte aqueous solution comprises isopropyl alcohol, glycerin, ethylene glycol, dimethylsulfoxide or dimethylformamide.

11. The apparatus for measuring an amount of hydrogen penetrated into a metal, according to claim 9, wherein the organic compound added to the electrolyte aqueous solution comprises isopropyl alcohol, glycerin, ethylene glycol, dimethylsulfoxide or dimethylformamide.

12. The apparatus according to claim 6, wherein the electrochemical cell filled with the electrolyte aqueous solution has a gas body disposed therein, the gas body being arranged without contacting the hydrogen detection surface.

13. The apparatus according to claim 7, wherein the electrochemical cell filled with the electrolyte aqueous solution has a gas body disposed therein, the gas body being arranged without contacting the hydrogen detection surface.

14. The apparatus according to claim 8, wherein the electrochemical cell filled with the electrolyte aqueous solution has a gas body disposed therein, the gas body being arranged without contacting the hydrogen detection surface.

15. The apparatus according to claim 9, wherein the electrochemical cell filled with the electrolyte aqueous solution has a gas body disposed therein, the gas body being arranged without contacting the hydrogen detection surface.

16. The apparatus according to claim 10, wherein the electrochemical cell filled with the electrolyte aqueous solution has a gas body disposed therein, the gas body being arranged without contacting the hydrogen detection surface.

17. The apparatus according to claim 11, wherein the electrochemical cell filled with the electrolyte aqueous solution has a gas body disposed therein, the gas body being arranged without contacting the hydrogen detection surface.
